(19) United States
(12) Patent Application Publication
(10) Pub. No.: US 2025/0232894 A1
(43) Pub. Date: Jul. 17, 2025

(54) METHOD FOR MANUFACTURING MULTI-CORE CABLE AND MULTI-CORE CABLE

(71) Applicant: YAZAKI CORPORATION, Tokyo (JP)

(72) Inventor: Ryuta HARA, Shizuoka (JP)

(73) Assignee: YAZAKI CORPORATION, Tokyo (JP)

(21) Appl. No.: 18/978,907

(22) Filed: Dec. 12, 2024

(30) Foreign Application Priority Data
Jan. 15, 2024 (JP) 2024-003754

(51) Int. Cl. H01B 7/18; H01B 7/00; H01B 13/24

(52) U.S. Cl. CPC H01B 7/1815; H01B 7/0009; H01B 13/24

(57) ABSTRACT

A method for manufacturing a multi-core cable including an inclusion, a plurality of electric wires twisted around the inclusion in a state that tension is applied to the inclusion, a shield portion provided around the electric wires, and a sheath is provided. The method includes a preparation step of preparing the inclusion having a diameter exceeding a predetermined diameter on assumption that tension is applied to the inclusion and the diameter is reduced to the predetermined diameter, a twisting step of twisting the electric wires while applying tension to the inclusion using the inclusion prepared in the preparation step as the central member, an inner wire manufacturing step of manufacturing an inner wire portion by providing the shield portion around the electric wires twisted by the twisting step, and an extrusion step of extrusion-molding a sheath to the inner wire portion manufactured in the inner wire manufacturing step.

### CROSS-REFERENCE TO RELATED APPLICATIONS

This application is based on and claims priority under 35 USC 119 from Japanese Patent Application No. 2024-003754 filed on Jan. 15, 2024, the contents of which are incorporated herein by reference.

### TECHNICAL FIELD

The present invention relates to a method for manufacturing a multi-core cable and a multi-core cable.

### BACKGROUND ART

In the related art, a multi-core cable has been proposed that includes a long inclusion provided at the center, a plurality of electric wires twisted around the inclusion, and a sheath covering the periphery of the inclusion and the electric wires (for example, see Patent Literature 1). Since this multi-core cable includes a tension member at the center, the multi-core cable can have a high tensile strength (for example, see Patent Literature 1).

### CITATION LIST

### Patent Literature

Patent Literature 1: JP2014-116254A

### SUMMARY OF INVENTION

Here, a multi-core cable such as that described in Patent Literature 1 needs to be manufactured by applying the tension to the inclusion in order to stabilize the twist pitch of the electric wires around the inclusion. Therefore, the diameter of the inclusion becomes slightly smaller than the initial diameter thereof. When the diameter of the inclusion becomes smaller than the initial diameter thereof, the circular structure is deformed when the inclusion and the surrounding electric wires are viewed in cross section, and the sheath is extrusion-molded in this state, so that the uniformity of the sheath thickness decreases. As a result of a decrease in the uniformity of the sheath thickness, the multi-core cable may cause wrinkles in the external appearance, or the abrasion resistance may decrease in a portion where the sheath thickness is small. Further, in the multi-core cable, an unnecessary increase in the amount of resin occurs in a portion where the sheath thickness is large, resulting in an increase in the cost of the electric wire.

The present invention has been made to solve such a problem in the related art, and an object of the present invention is to provide a method for manufacturing a multi-core cable and a multi-core cable that can improve the uniformity of a sheath.

A method for manufacturing a multi-core cable of the present invention is a method for manufacturing a multi-core cable by extrusion-molding a sheath to an inner wire portion, the inner wire portion including an inclusion having a circular cross-sectional shape as an elongated central member, a plurality of electric wires twisted around the inclusion in a state in which tension is applied to the inclusion, and an outer layer provided around the plurality of electric wires. The method includes a preparation step of preparing the inclusion having a diameter exceeding a predetermined diameter on assumption that tension is applied to the inclusion and the diameter is reduced to the predetermined diameter; a twisting step of twisting the plurality of electric wires while applying tension to the inclusion using the inclusion prepared in the preparation step as the central member; an inner wire manufacturing step of manufacturing the inner wire portion by providing the outer layer around the plurality of electric wires twisted by the twisting step; and an extrusion step of extrusion-molding a sheath to the inner wire portion manufactured in the inner wire manufacturing step.

Further, a multi-core cable of the present invention includes an inclusion having a circular cross-sectional shape as an elongated central member; a plurality of electric wires that are provided around the inclusion and that are twisted together; an outer layer that is provided around the plurality of electric wires; and a sheath that is in contact with the outer layer. The inclusion comes into contact with the plurality of electric wires on an outer peripheral side of the inclusion in a state in which the inclusion is subjected to tension and is thinner than when in a free state. The plurality of electric wires are arranged in a circular cross-sectional shape.

According to the present invention, it is possible to provide a method for manufacturing a multi-core cable and a multi-core cable that can improve the uniformity of a sheath.

### BRIEF DESCRIPTION OF DRAWINGS

FIG. 1 is a cross-sectional view showing a multi-core cable according to an embodiment of the present invention;

FIG. 2 is a cross-sectional view showing a multi-core cable according to a comparative example;

FIG. 3 is a process diagram showing a method for manufacturing a multi-core cable according to the present embodiment;

FIG. 4 is a table showing conditions for manufacturing a multi-core cable according to the present embodiment;

FIG. 5 is a diagram showing the state of a scrape test; and

FIG. 6 is a graph showing the results of the scrape test.

### DESCRIPTION OF EMBODIMENTS

Hereinafter, the present invention will be described with reference to a preferred embodiment. The present invention is not limited to the embodiment described below, and the embodiment can be appropriately changed without departing from the gist of the present invention. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

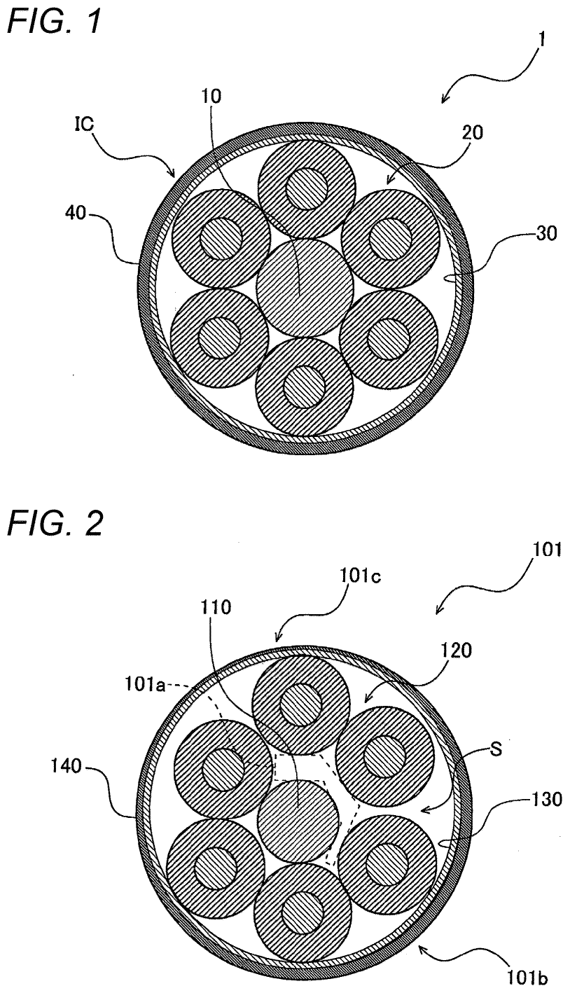

FIG. 1 is a cross-sectional view showing a multi-core cable according to an embodiment of the present invention. As shown in FIG. 1, a multi-core cable 1 includes an inclusion 10, a plurality of electric wires 20, a shield portion (an outer layer) 30, and a sheath 40.

The inclusion 10 is a so-called tension member, is a central member that has a circular cross-sectional shape, and is formed into an elongated shape similarly to the multi-core cable 1. In the present embodiment, the inclusion 10 is in a state in which the tension is applied in the longitudinal direction thereof, and has a diameter smaller than that in a free state (a state in which the inclusion has a natural length).

The plurality of electric wires 20 are, for example, insulated electric wires each having a conductor and an insulator. The plurality of electric wires 20 are twisted around the inclusion 10 in a state in which the tension is applied. In the present embodiment, all of the plurality of electric wires 20 have the same dimension, shape, and material. Alternatively, a part of the plurality of electric wires 20 may be different in one or more of the dimension, shape, and material. The number of electric wires 20 is not limited to six.

The shield portion 30 protects the internal electric wire 20 from, for example, noise that arrives from the outside, and is provided around the plurality of electric wires 20. The shield portion 30 is made of metal foil or a braid formed by braiding metal wires or the like. The shield portion 30 may be made of metal-plated fibers braided into a braid or the like, may be made of metal-plated nonwoven fabric, or the like. When the shield portion 30 is made of metal foil, the metal foil may be wound in a spiral shape or may be attached vertically.

The sheath 40 is an insulating member that is provided on and in contact with the shield portion 30. The sheath 40 is formed on the shield portion 30 by performing extrusion molding on an inner wire portion IC that includes the inclusion 10, the plurality of electric wires 20, and the shield portion 30.

Here, in the multi-core cable 1 according to the present embodiment, the tension is applied to the inclusion 10, and the inclusion 10 is made thinner than in the free state to have a predetermined diameter. The plurality of electric wires 20 are twisted around the inclusion 10, which has been applied such tension and has the predetermined diameter, so that the electric wires 20 have a circular cross-sectional shape. In this state, the electric wires 20 are in contact with the inclusion 10, and are also in contact with the adjacent electric wires 20.

In the present embodiment, the circular cross-sectional shape refers to a shape that has a value (a circularity ratio) of, for example, 0.05 or less, the value being obtained by dividing the circularity by the average value of the maximum and minimum circle diameters in a cross section orthogonal to the longitudinal direction. More specifically, the maximum circle refers to the circumscribing circle of the outermost one of the plurality of electric wires 20, with the center of the inclusion 10 defined as the center of the circle. The maximum circle diameter is the diameter of the maximum circle. The minimum circle refers to the circumscribing circle of the innermost one of the plurality of electric wires 20, with the center of the inclusion 10 defined as the center of the circle. The minimum circle diameter is the diameter of the minimum circle. The circularity generally refers to a value obtained by dividing the difference between the maximum circle diameter and the minimum circle diameter by 2. In the present embodiment, the circularity ratio refers to a value obtained by further dividing the circularity by the average value of the maximum circle diameter and the minimum circle diameter, and when this circularity ratio is 0.05 or less, it can be said that the plurality of electric wires 20 are arranged in the circular cross-sectional shape.

FIG. 2 is a cross-sectional view showing a multi-core cable according to a comparative example. As shown in FIG. 2, a multi-core cable 101 according to the comparative example includes an inclusion 110, a plurality of electric wires 120, a shield portion 130, and a sheath 140. The plurality of electric wires 120 and the shield portion 130 according to the comparative example are the same as those described with reference to FIG. 1.

In the multi-core cable 101 according to the comparative example, the inclusion 110 having a predetermined diameter is prepared, and the plurality of electric wires 120 are twisted by applying the tension to the inclusion 110 having the predetermined diameter. That is, in the multi-core cable 101 according to the comparative example, the inclusion 110 has the predetermined diameter in the free state. Therefore, the diameter of the inclusion 110 is smaller than the predetermined diameter in a state in which the tension is applied. Therefore, when the plurality of electric wires 120 are twisted around such an inclusion 110, it is difficult to say that any one of the plurality of electric wires 120 is separated from the inclusion 110 as indicated by a reference sign 101a and has a circularity ratio exceeding 0.05, and that the plurality of electric wires 120 are arranged in the circular cross-sectional shape. In particular, when the circularity ratio deteriorates, there may be a location S where the adjacent electric wires 120 are separated from each other.

The shield portion 130 is formed in a state in which the circularity ratio exceeds 0.05, and then the sheath 140 is extrusion-molded, so that the uniformity of the thickness of the sheath 140 decreases. For example, in the multi-core cable 101 according to the comparative example, the sheath thickness is ensured at the location indicated by a reference sign 101b, but the sheath is thin at the location indicated by a reference sign 101c, and the thickness cannot be ensured.

As described above, in the multi-core cable 101 according to the comparative example, the uniformity of the sheath thickness decreases, and wrinkles in the external appearance are generated or the abrasion resistance decreases in the portion (the portion indicated by the reference sign 101c) where the sheath thickness is small. Further, in the multi-core cable 101 according to the comparative example, an unnecessary increase in the amount of resin occurs in the portion (the portion indicated by the reference sign 101b) where the sheath thickness is large, resulting in an increase in the cost of the electric wire.

On the other hand, in the multi-core cable 1 according to the present embodiment, the inclusion 10 whose diameter is larger than the predetermined diameter is prepared in advance so as to have the predetermined diameter in a state in which the tension is applied to the inclusion 10, and the multi-core cable 1 is manufactured using such an inclusion 10. As a result, as shown in FIG. 1, the plurality of electric wires 20 are arranged in the circular cross-sectional shape such that the electric wires 20 come into contact with the inclusion 10 and have a circularity ratio of 0.05 or less. Further, adjacent ones of the plurality of electric wires 20 are in contact with each other.

As described above, in the multi-core cable 1 according to the present embodiment, the plurality of electric wires 20 have a high degree of circularity, and when the shield portion 30 is provided and the sheath 40 is extrusion-molded, the uniformity of the sheath thickness is improved.

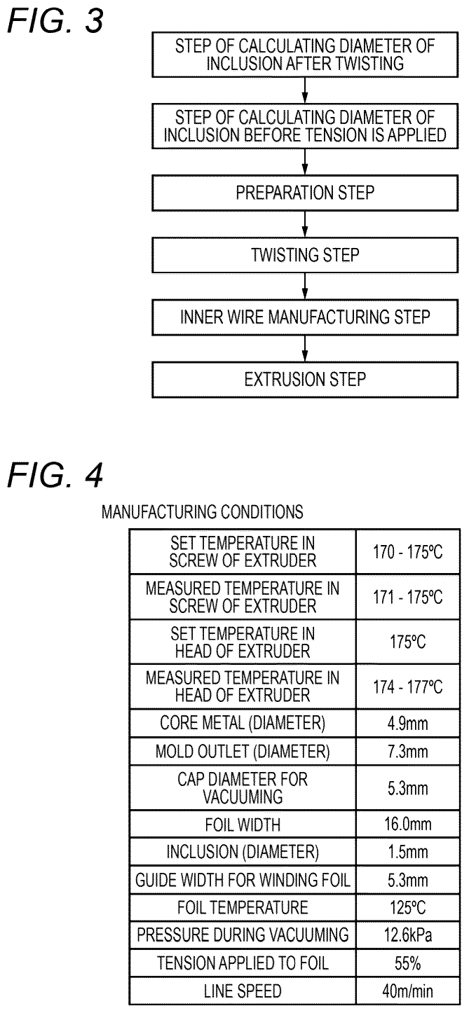

FIG. 3 is a process diagram showing a method for manufacturing the multi-core cable 1 according to the present embodiment. First, as shown in FIG. 3, a step of calculating the diameter of the inclusion 10 after twisting is executed. In this step, the diameter of the inclusion 10 after twisting is calculated based on the diameter of the multi-core cable 1 to be manufactured, the diameter of each of the plurality of electric wires 20, and the like such that the inner wire portion IC becomes more perfectly circular.

Next, a step of calculating the diameter of the inclusion 10 before the tension is applied (before twisting) is executed. Here, during manufacturing, the amount of the tension to be applied is known in advance. Therefore, the diameter of the inclusion 10 before the tension is applied (before the twisting) is calculated based on the tension applied to the inclusion 10 and the diameter of the inclusion 10 after twisting.

Next, the inclusion 10 having the calculated diameter before the tension is applied is prepared (a preparation step). In the case of using the inclusion 10 having a cross-sectional area of 1.77 mm² before the tension is applied, it is assumed that the tension to be applied to the inclusion 10 is approximately 20 MPa (35.4 N). In this case, it goes without saying that a material having a tensile yield stress of more than 20 MPa, that is, a material (for example, polypropylene (PP) or polyamide (PA)) that has a target diameter even when the tension described above is applied is selected for the inclusion 10.

Thereafter, a twisting step of twisting the plurality of electric wires 20 around the inclusion 10 is performed (a twisting step). At this time, the tension is applied to the inclusion 10. Since twisting is performed, the plurality of electric wires 20 are also twisted while the tension is applied thereto. In this twisting step, the inclusion 10 has the predetermined diameter by the tension applied to the inclusion 10, and the plurality of electric wires 20 are twisted into the circular cross-sectional shape having a circularity ratio of, for example, 0.05 or less.

Next, the shield portion 30 is formed on the plurality of electric wires 20 that are twisted in the twisting step (an inner wire manufacturing step). Accordingly, the inner wire portion IC before extrusion molding is manufactured. Thereafter, the sheath 40 is extruded onto the inner wire portion IC that is manufactured in the inner wire manufacturing step (an extrusion step).

Accordingly, the multi-core cable 1 is manufactured. In particular, since the plurality of electric wires 20 are arranged in the circular cross-sectional shape, the inner wire portion IC provided with the shield portion 30 is also likely to have a circular cross-sectional shape. Therefore, the sheath 40 thereafter has high uniformity and covers the inner wire portion IC.

An example of the multi-core cable 1 manufactured by the manufacturing method according to the present embodiment will be described, along with the result of a scrape test performed on the multi-core cable 1 manufactured by the example.

FIG. 4 is a table showing conditions for manufacturing the multi-core cable 1 according to the present embodiment. In the example shown in FIG. 4, the shield portion 30 is made of metal foil, and the material of the inclusion 10 is polyvinyl chloride (PVC). The number of the plurality of electric wires 20 is six.

As shown in FIG. 4, when the sheath 40 is extruded, the set temperature in the screw (not shown) of the extruder (not shown) varies depending on the location, and is 170° C. or higher and 175° C. or lower. The measured temperature is 171° C. or higher and 175° C. or lower. The set temperature of the head (not shown) of the extruder is 175° C., and the measured temperature is 174° C. or higher and 177° C. or lower.

The core metal diameter is 4.9 mm, and the mold outlet diameter is 7.3 mm. The cap diameter for vacuuming the periphery of the inner wire portion IC and tightly sealing the sheath 40 is 5.3 mm, the foil width is 16.0 mm, and the diameter of the inclusion 10 (after the tension is applied) is 1.5 mm.

The width of the guide around which the foil is wound is 5.3 mm, the foil temperature is 125° C., and the pressure in the periphery (in the vacuum state) of the inner wire portion IC is 12.6 kPa. The tension that is applied to the foil is 55%, and the line speed is 40 m/min.

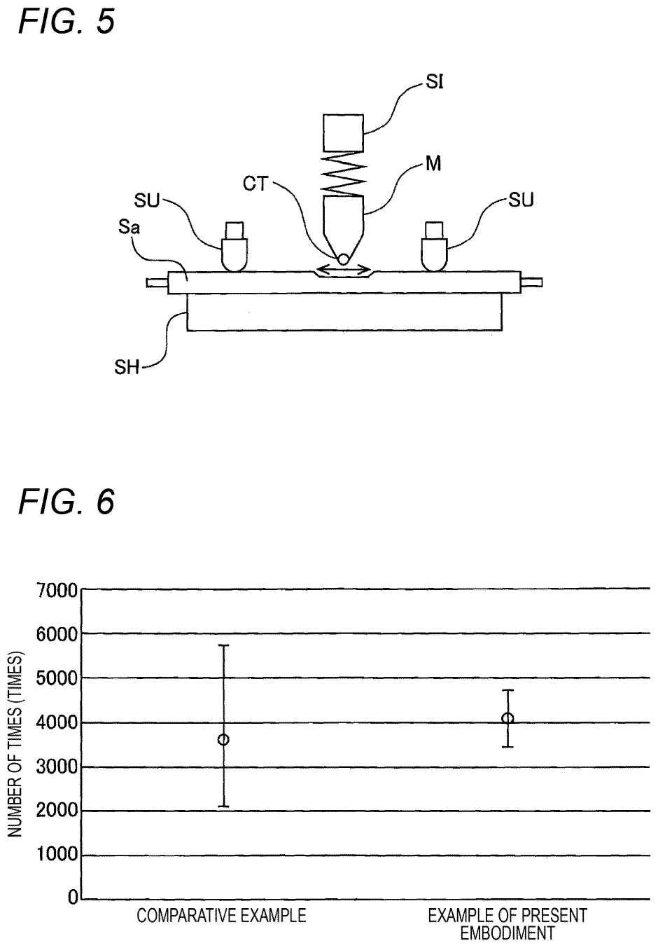

The multi-core cable 1 manufactured under the above manufacturing conditions and the multi-core cable 101 according to the comparative example are subjected to a scrape test. FIG. 5 is a diagram showing the state of a scrape test.

In the scrape test, a sample Sa of the multi-core cables 1 and 101 having a length of approximately 750 mm is fixed to a sample holder SH by a support tool SU. Then, a metal plunger M including a conductive distal end portion CT such as a spring wire or hard steel wire at the distal end is brought into contact with the sample Sa in a state in which a load of 7=0.05 N is applied thereto by a weight SI. The spring wire is specified in ISO 8458-2, and the hard steel wire is a hard steel wire type C (SW-C) specified in JIS G 3521.

Next, at room temperature of 23±1° C., the metal plunger M is caused to reciprocate 15.5±1 mm at a speed of 50 times/min to 60 times/min. Then, the number of reciprocations until the shield portions 30 and 130 and the conductive distal end portion CT come into contact with each other is measured.

After one location is measured, the sample Sa is moved by approximately 100 mm in the longitudinal direction, is rotated by 90 degrees in the clockwise direction, and is fixed by the support tool SU. Then, the number of reciprocations is measured in the same manner as described above. Then, the measurement is performed four times in total, and the lowest value is used as the result.

FIG. 6 is a graph showing the results of the scrape test. In FIG. 6, the number of samples is five, and the maximum value, the average value, and the minimum value are shown.

As shown in FIG. 6, as a result of the scrape test, the number of reciprocations of the multi-core cable 101 according to the comparative example was in a wide range from approximately 2100 to approximately 5800. The average number of reciprocations was approximately 3600. On the other hand, in the example of the multi-core cable 1 according to the present embodiment, the number of reciprocations was approximately 3500 to approximately 4800, which was a narrower range than that in the comparative example. That is, it was found that the uniformity of the sheath thickness was improved. The average number of reciprocations was approximately 4100, and an improvement in the average number of reciprocations was also confirmed.

In addition, as a result of measuring the sheath thickness at the locations, the sheath thickness of the multi-core cable 101 according to the comparative example was 0.38 mm or more and 0.61 mm or less. On the other hand, the sheath thickness of the example of the multi-core cable 1 according to the present embodiment is 0.37 mm or more and 0.54 mm or less. Therefore, it was also found that the uniformity of the sheath thickness was improved based on the measured value of the sheath thickness.

Further, when the external appearances of the multi-core cables 1 and 101 were visually inspected, wrinkles were found at various locations in the multi-core cable 101 according to the comparative example. On the other hand, no wrinkles were found in the example of the multi-core cable 1 according to the present embodiment.

In this way, in the method for manufacturing the multi-core cable 1 according to the present embodiment, the inclusion 10 having a diameter exceeding the predetermined diameter is prepared on the assumption that the tension is applied and the diameter is reduced to the predetermined diameter. Therefore, the plurality of electric wires 20 are twisted around the inclusion 10 in a state in which the inclusion 10 has approximately the assumed predetermined diameter. As a result, compared to a case in which the inclusion 110 is not assumed to become thin and the inclusion 110 having the predetermined diameter is prepared in advance, the inner wire portion IC has a more circular cross-sectional shape. Accordingly, when the sheath 40 is then extrusion-molded, the uniformity of the sheath thickness is increased. Therefore, it is possible to provide a method for manufacturing the multi-core cable 1 that can improve the uniformity of the sheath 40.

In the multi-core cable 1 according to the present embodiment, the inclusion 10 comes into contact with the plurality of electric wires 20 on the outer peripheral side of the inclusion 10 in a state in which the inclusion 10 is subjected to the tension and is thinner than when in the free state, and the plurality of electric wires 20 are arranged in the circular cross-sectional shape. Therefore, although the inclusion 10 is thinned due to the tension, each of the electric wires 20 comes into contact with the inclusion 10 and has a circular cross-sectional shape. As described above, in the multi-core cable 1, when the tension is applied to the inclusion 10 to make the inclusion 10 thinner, none of the plurality of electric wires 20 is separated from the inclusion 10 and is arranged in a state of being deformed from the circular cross-sectional shape. Since the plurality of electric wires 20 are arranged in the circular cross-sectional shape, the shield portion 30 also has a cross-sectional shape that is close to the circular cross-sectional shape, and the sheath 40 that is formed by extrusion on this shield portion 30 has a uniform thickness. Therefore, it is possible to provide the multi-core cable 1 that can improve the uniformity of the sheath 40.

Although the present invention is described above based on the embodiment, the present invention is not limited to the embodiment described above, a modification may be made without departing from the gist of the present invention, and the known or well-known techniques may be combined.

For example, in the embodiment described above, the shield portion 30 is provided on the outside of the plurality of electric wires 20. However, the plurality of electric wires 20 are not limited to being wrapped with the shield portion 30, and may be wrapped with, for example, a resin tape or the like. Further, the shield portion 30, the tape, or the like may be provided on the outside of the plurality of electric wires 20 not only in one layer, but also in two or more layers.

In addition, when the multi-core cable 1 described above includes the shield portion 30 as an outer layer, the multi-core cable 1 may further include a separate drain wire, or may include a drain wire as one of the plurality of electric wires 20.

What is claimed is:

1. A method for manufacturing a multi-core cable by extrusion-molding a sheath to an inner wire portion, the inner wire portion including an inclusion having a circular cross-sectional shape as an elongated central member, a plurality of electric wires twisted around the inclusion in a state in which tension is applied to the inclusion, and an outer layer provided around the plurality of electric wires, the method comprising:
a preparation step of preparing the inclusion having a diameter exceeding a predetermined diameter on assumption that tension is applied to the inclusion and the diameter is reduced to the predetermined diameter;
a twisting step of twisting the plurality of electric wires while applying tension to the inclusion using the inclusion prepared in the preparation step as the central member;
an inner wire manufacturing step of manufacturing the inner wire portion by providing the outer layer around the plurality of electric wires twisted by the twisting step; and
an extrusion step of extrusion-molding a sheath to the inner wire portion manufactured in the inner wire manufacturing step.

2. A multi-core cable comprising:
an inclusion having a circular cross-sectional shape as an elongated central member;
a plurality of electric wires that are provided around the inclusion and that are twisted together;
an outer layer that is provided around the plurality of electric wires; and
a sheath that is in contact with the outer layer,
wherein the inclusion comes into contact with the plurality of electric wires on an outer peripheral side of the inclusion in a state in which the inclusion is subjected to tension and is thinner than when in a free state, and
wherein the plurality of electric wires are arranged in a circular cross-sectional shape.
